(19) United States
(12) Patent Application Publication
(10) Pub. No.: US 2016/0210061 A1
(43) Pub. Date: Jul. 21, 2016

(54) ARCHITECTURE FOR A TRANSPARENTLY-SCALABLE, ULTRA-HIGH-THROUGHPUT STORAGE NETWORK

(71) Applicant: Tektronix, Inc., Beaverton, OR (US)

(72) Inventors: Adrian C. Soncodi, Plano, TX (US); John P. Curtin, Richardson, TX (US); Ryan L. Pipkin, Prosper, TX (US)

(21) Appl. No.: 14/602,016

(22) Filed: Jan. 21, 2015

(51) Int. Cl. G06F 3/06

(52) U.S. Cl. CPC G06F 3/0613; G06F 3/0689; G06F 3/0665

(57) ABSTRACT

A data storage system includes storage nodes configured to receive data access requests from client applications. The data storage system further includes data processing functions associated with the storage nodes. Each data processing function is configured to be performed by the storage nodes. The data storage system further includes data repository units operatively coupled to the storage nodes. The data repository units are configured to store and retrieve data items associated with the received data access requests. The received data access requests are analyzed and data item streams associated with the requests are categorized. The categorized data item streams are decomposed into data segments. Availability parameters associated with each data repository unit are determined. The data segments are distributed among the data repository units based on user-configurable policies associated with identified data item category and based on the determined availability parameters associated with each of the data repository units.

### FIELD OF THE INVENTION

Embodiments of the present invention relate to network storage, and particularly to architecture for a transparently-scalable, ultra-high-throughput storage network.

### BACKGROUND OF THE INVENTION

Reliable and efficient storage of data and, in particular, data used by enterprises is becoming increasingly important. Various data duplication, backup and/or data minoring techniques are used by enterprise data storage systems. Typically, the data is distributed over several data servers, so that a crash of one server or loss of the connection to that server does not affect the data integrity.

Various approaches exist that enable resources such as data centers and Internet-Protocol (IP)-based networks to scale as the needs of the various users and applications increase. In some cases, this requires the purchase of large, expensive hardware that typically provides more capacity than is immediately necessary. For a large number of resources to be used, this can provide a significant expenditure and overhead, which can be undesirable in many instances and likely requires manual calibration/tuning based on hardcoded Quality of Storage (QoSt) concepts.

It is desired to have the level or redundancy, the level of reliability and the level of data availability as a single service, so a user can have choices and can select certain guarantees of data availability and of quality of data storage.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a data storage system in a high-capacity network is provided. The data storage system includes a plurality of storage nodes configured to receive data access requests from one or more client applications. The data storage system further includes a plurality of data processing functions associated with the plurality of storage nodes. Each of the plurality of data processing functions is configured to be performed by one or more of the plurality of storage nodes. The data storage system further includes a plurality of data repository units operatively coupled to the plurality of storage nodes. The plurality of data repository units is configured to store and retrieve data items associated with the received data access requests. The received data access requests are analyzed and data item streams associated with the received data access requests are categorized by the plurality of storage nodes. The categorized data item streams are decomposed into a plurality of data segments. Availability parameters associated with each of the plurality of data repository units are determined by the plurality of storage nodes. The plurality of data segments is distributed among the plurality of data repository units based on a user-configurable policy associated with identified data item category and based on the determined availability parameters associated with each of the plurality of data repository units.

In another aspect, a computer program product for storing and retrieving data in a high-capacity network having a plurality of storage nodes is provided. The computer program product comprises one or more computer-readable storage devices and a plurality of program instructions stored on at least one of the one or more computer-readable storage devices. The plurality of program instructions includes program instructions to receive data access requests from one or more client applications. The plurality of program instructions further includes program instructions to analyze and categorize data items associated with the received data access requests. The plurality of program instructions further includes program instructions to decompose the categorized data item streams into a plurality of data segments. The plurality of program instructions further includes program instructions to determine availability parameters associated with each of a plurality of data repository units operatively coupled to the plurality of storage nodes. The plurality of program instructions further includes program instructions to distribute the plurality of data segments among the plurality of data repository units based on a user-configurable policy associated with identified data item category and based on the determined availability parameters associated with each of the plurality of data repository units.

### BRIEF DESCRIPTION OF THE DRAWINGS

The accompanying appendices and/or drawings illustrate various, non-limiting, examples, inventive aspects in accordance with the present disclosure:

FIG. 1 illustrates a network computing environment in which aspects of the invention are implemented in accordance with certain illustrative embodiments;

FIG. 2 is a block diagram illustrating a further view of ultra-high throughput storage management architecture, in accordance with an illustrative embodiment of the present invention;

FIG. 3 is a flowchart of operational steps of the storage manager module of FIG. 1, in accordance with an illustrative embodiment of the present invention;

FIG. 4 is a flowchart of operational steps of the stream processor module of FIG. 1, in accordance with an illustrative embodiment of the present invention;

FIG. 5 is a flowchart of operational steps of the stream controller module of FIG. 1, in accordance with an illustrative embodiment of the present invention; and

FIG. 6 is a block diagram illustrating a typical storage node that may be employed to implement some or all processing functionality described herein, according to some embodiments.

### DETAILED DESCRIPTION OF CERTAIN EMBODIMENTS

The present invention is now described more fully with reference to the accompanying drawings, in which illustrated embodiments of the present invention are shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described below. One skilled in the art will appreciate further features and advantages of the invention based on the below-described embodiments. Accordingly, the invention is not to be limited by what has been particularly shown and described, except as indicated by the appended claims.

In exemplary embodiments, a computer system component may constitute a “module” that is configured and operates to perform certain operations as described herein below. Accordingly, the term “module” should be understood to encompass a tangible entity, be that an entity that is physically constructed, permanently configured (e.g., hardwired) or temporarily configured (e.g. programmed) to operate in a certain manner and to perform certain operations described herein.

Described embodiments of the present invention concern a comprehensive distributed data management platform that includes a variety of mission critical applications, large number of application servers running different operating systems, processing nodes, storage units with differing capabilities, and many network elements that interconnect application servers with storage units. Transparently scalable storage management platform described herein deals with many storage aspects, such as, for example, but not limited to, storage network topology, performance, recoverability, capacity planning and security and handles transient as well as persistent aspects: e.g., processing real-time data access I/O requests (transient) and data (persistent) received from a variety of both data traffic-generating and data traffic-receiving distributed client applications. The described embodiments of the present invention allow the integration of business objectives, specifying resource usage, availability, recoverability priorities; system model, specifying what changes should be noticed and how; metrics, specifying what and how to measure in the storage network, and when to raise “alarms”; and service contract, specifying the monitorable interactions with other components (e.g. applications) of the described ultra-high throughput storage infrastructure.

Generally, there is a number of quality-related parameters p₁, p₂ . . . pₙ that can characterize the storage traffic. These parameters include, but not limited to, throughput, retention time, priority (i.e., relative importance), robustness (i.e., redundancy or replication requirements) and retrieval speed. It is noted that the ranges [p_{iMin}, p_{iMax}] of quality related parameters may vary rapidly and unpredictably over time and may be extremely large at least in some cases. For example, stream bandwidth can very unpredictably from very low to very large. As another non-limiting example, the retention period for some stream items may vary from very short to very long. Thus, the overall set of parameter values that QoSt system should support can be represented by a hypercube [p_{1Min}, p_{1Max}]*[p_{2Min}, p_{2Max}]* . . . *[p_{nMin}, p_{nMax}]. In order to fully support this set of parameter values the data management platform should include the entire hypercube. In other words, this type of infrastructure would require having enough hardware resources to ensure contemporaneously enormous capacity, enormous speed, multiple levels of replication, and the like. In most cases, the cost of such hardware infrastructure quickly becomes prohibitive by orders of magnitude.

The storage systems known in the art do not address the data QoSt aspect or they address it with insufficient granularity. Additionally, such systems typically handle QoSt attributes within a limited range of values, which may be too low to support massive scaling capability. For example, if the storage system is engineered to contain only a fixed fraction of the above referenced hypercube (typically, quite small), then it will be substantially inflexible upon reaching its engineered limitations with respect to unpredictable variance in properties of storage traffic, location and frequency of data recall. Such a system would then abruptly drop, truncate or degrade at least a fraction of the storage traffic merely based on a single parameter value being out of bounds, even though various compromises between the value of this particular parameter, the values of the remaining parameters and the amount of available resources may have been reached.

Other drawbacks of known storage systems include: associating differentiated treatment of data to fixed hardware or software configuration, thus making it difficult to adapt to ever changing traffic patterns and lack of built-in policies and mechanisms to fully enable differentiated treatment of data. In many known storage systems various QoSt-related aspects of the data are visible to various mission critical applications, thus requiring such applications to make storage-related decisions based on the known QoSt-related aspects of data. This type of decision making process further requires the applications to be aware of the storage network topology, as well as many other deployment-specific and configuration-specific details in order to achieve specified availability, retention and recovery goals under various disaster scenarios. In some cases the applications may be unable to make suitable storage decisions if the storage behavior can only be controlled by a specific set of common attributes. In other cases, if the storage management is based solely on decisions that are made by the individual applications, then there is a possibility that inefficient or inappropriate storage decisions may be taken, as each of the applications does not have any information regarding the end-to-end QoSt for the data flow or other application data flows over a large storage network. In yet some other cases even if an individual application makes valid storage decisions, its decision methods may become invalid over time when the traffic patterns change.

Various embodiments are disclosed herein to address the above mentioned shortcomings in supporting a highly flexible and highly scalable storage system consisting of limited and variable storage resources. A high-throughput QoSt-enabled network avoids the shortcomings of the known storage solutions by taking into the account all the available resources and all the storage traffic parameters combined, at any time and by obtaining an optimal performance and optimal data retention policy within constraints of currently available hardware. A heterogeneous storage system can evolve over time and can include an adequate combination of newly installed and relatively large storage devices and older/smaller storage devices. However, even such heterogeneous platform is constrained by physical limitations of its resources. Advantageously, upon reaching resource limitation, the distributed storage management framework then applies a number of user-configured policies to determine the best compromise that can be made on the totality of data traffic to be stored. This effectively amounts to giving the application/users the best possible “value” in accordance to the defined policies. Flexibility is also achieved by allowing the policies themselves to vary in time or according to additional meta-rules. These flexible policies serve as a mechanism for dynamic adaptation to specific application deployment model without requiring any iterative changes to already deployed client applications.

A preferred embodiment of the present invention introduces a new type of specific data organization, flexible arrangement of storage network entities and selective assignment of data processing functions (which may include two or more different process levels) to a plurality of storage nodes, which collectively enable substantial improvement in real-time performance of the storage network. In accordance with the preferred embodiment, optimal resource utilization may be achieved by allowing one or more client applications to specify different treatment for different types of stored data items. In one aspect, the disclosed distributed data management platform allows to scale both its processing capacity and storage network bandwidth capacity without substantial degradation of real-time services. Advantageously, the disclosed data management platform employs an elaborate QoSt supporting framework, which is based primarily on processing rules that are consistent with the full set of pre-defined data attributes. Such processing rules relieve various client applications of the burden of storage management for shared data, without removing the user's/application's ability to prioritize substantially granular segments of storage data. In another aspect, robustness of data storage system is provided to users through highly flexible operations, such as an ability to adapt storage/retrieval and data processing operations to various categories of data items, while functioning in an efficient way that is transparent to an application using the disclosed storage network. Various embodiments of the present invention introduce a new approach aimed at customizing substantially all general functions of the data management platform through well-defined Application Programming Interface (API) function calls. Advantageously, as a non-limiting example, the distributed QoSt-based storage network supports an adaptive filtering on new fields within a predefined data item type. In some embodiments, adaptation is relative to the storage traffic characteristics at any given moment in time.

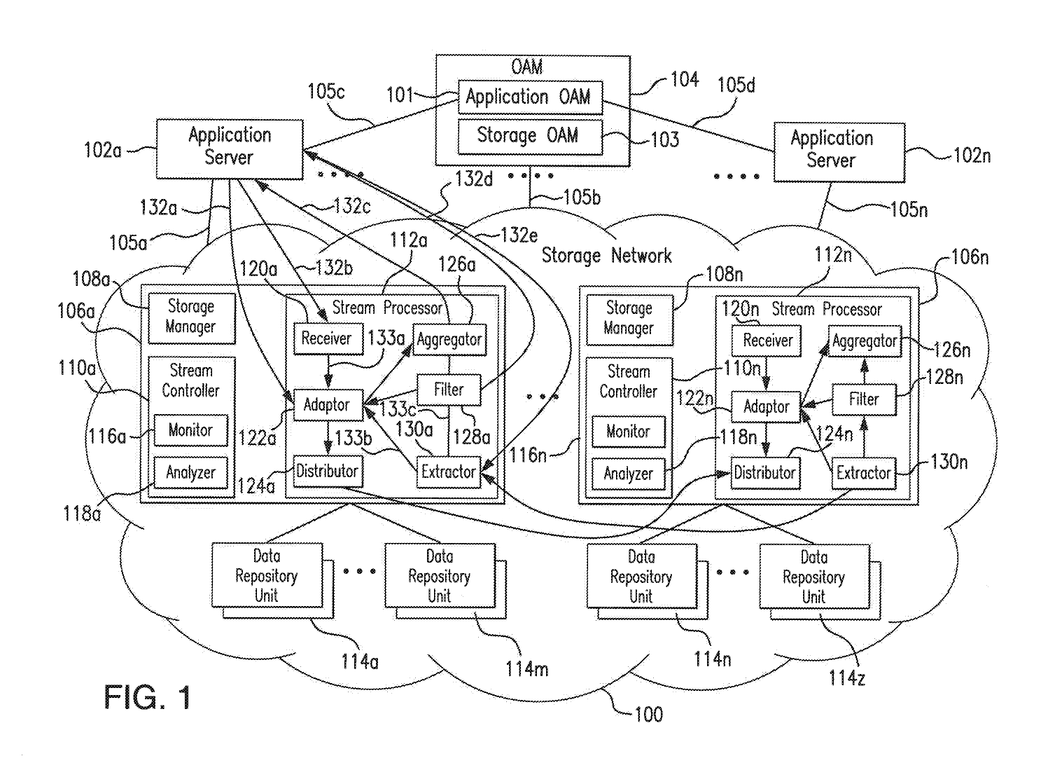

Turning to FIG. 1, FIG. 1 is intended to provide a brief, general description of an illustrative and/or suitable exemplary network computing environment in which embodiments of the below described present invention may be implemented. A particular embodiment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

As illustrated in FIG. 1, a plurality of application servers 102a-102n may transmit data to the storage network 100, which in turn distributes it over storage resources referred to herein as data repository units (referred to herein individually as “data repository unit 114” and collectively as “data repository units 114a-114z” or as “data repository units 114”). Storage nodes (referred to herein individually as “storage node 106” and collectively as “storage nodes 106a-106n” or as “storage nodes 106”) include various QoSt based storage management related modules (e.g., storage manager modules (referred to herein individually as “storage manager 108” and collectively as “storage manager modules 108a-108n” or as “storage managers 108”), stream controller modules (referred to herein individually as “stream controller 110” and collectively as “stream controller modules 110a-110n” or as “stream controllers 110”) and stream processor modules (referred to herein individually as “stream processor 112” and collectively as “stream processor modules 112a-112n” or as “stream processors 112”) configured to route data, created by application server 102a-102n applications (such as database applications or any other data processing application known in the art) to data repository units 114 based on the QoSt characteristics of the received data items. The concerted efforts of the illustrated modules allow the storage network 100 to dynamically adapt to data item formats provided by the plurality of application servers 102a-102n rather than requiring extensive development, even for simple applications, of interfaces that present the incoming data items to the storage network 100 according to a pre-defined data model.

FIG. 1 shows that in one exemplary embodiment a first plurality of data repository units, such as 114a-114m, may be directly attached to one storage node 106a, while a second plurality of data repository units, such as 114n-114z, may be directly attached to another storage node 106n. The application servers 102a-102n may comprise any computational device known in the art (e.g., a workstation, personal computer, mainframe, server, laptop, hand held computer, tablet, telephony device, network appliance, etc.).

The data repository units 114 may comprise any storage device, storage system or storage subsystem known in the art that directly connects to the storage network 100 or is attached to one or more storage nodes, such as the data repository units 114a-114z directly attached to storage nodes 106a-106n. The data repository units 114 may comprise a Just a Bunch of Disks (JBOD), Redundant Array of Independent Disk (RAID), Network Attached Storage (NAS), a virtualization device, tape library, optical disk library, etc.

The storage network 100 may comprise any high-speed low-latency network system known in the art, such as a Local Area Network (LAN), Storage Area Network (SAN), Intranet, Wide Area Network (WAN), the Internet, etc. LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

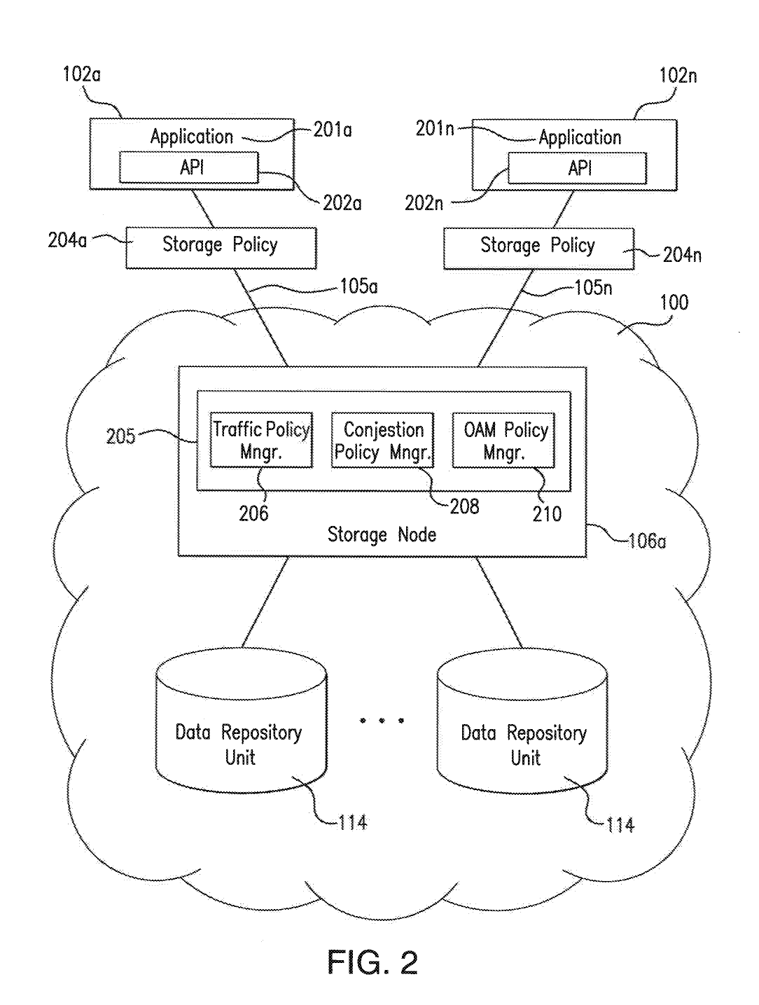

The storage nodes 106a-106n may comprise any device capable of managing application access to a storage resource, such as any server class machine, a storage controller, enterprise server, and the like. It is noted that FIGS. 1 and 2 depict a simplified two-tiered model of the QoSt-based storage network 100. In various embodiments, the storage nodes 106 may comprise a hierarchy of sub-nodes. The various functions supported by these sub-nodes may be distributed among several storage nodes 106. Furthermore, at least some of the storage nodes 106 may not support all the functions. According to embodiments of the present invention, the data repository units 114 are viewed by the storage network 100 as the lowest-level entities in this hierarchy. One of the challenges by the QoSt based storage network's framework 100 is that data repository units 114 have highly uneven parameters (capacities, throughputs, etc.) that need to be managed.

As shown in FIG. 1, in one embodiment, application instances may be distributed across a number of network nodes (application servers 102a-102n), each instance capable of connecting to any available storage node 106a-106n with no substantial limitations regarding the amount or type of data it may send (except where physical boundary, policy or limitations of bandwidth may apply). In various embodiments, the application instances running on the application servers 102a-102n are not tasked with allocating storage resources (e.g., I/O bandwidth, load balancing, etc.), configuring (e.g., assigning IP addresses, VLANs, etc.) or monitoring bandwidth of each data repository units 114, maintaining separate file systems, and the like. It should be apparent that all of these are managed internally by the storage nodes 106a-106n transparently to the application instances.

According to one embodiment of the present invention, connectivity to the storage network 100 may be defined in terms of generic pipes 105 and 132 of raw data items. Data piping between distributed applications and storage network 100 (e.g., a writer application on the application server 102 and a storage management application, i.e. storage manager 108a on the storage node 106a) includes the writer application writing data items to a pipe, i.e. pipe 132b, and the storage management application reading data items from the pipe, i.e. pipe 132c. The pipe is a conduit of one or more streams of data items. It is noted that each pipe 105 and 132 can carry data items from any number of streams and from any number of initiators (i.e., applications). For example, any application running on the application server 102a can connect to the storage network 100 through pipe 105a at any point, without requiring any configuration. In other words, an application does not need to know which pipe 105a-105n is connected to which of the plurality of storage nodes 106a-106n, etc. The plurality of storage nodes 106a-106n is provided in the disclosed architecture for performing data management operations including adaptive priority data filtering, among other functionality. This adaptive data filtering may include, but not limited to, prioritized data capture, classification and filtering. In an aspect of the invention, the plurality storage nodes 106a-106n may include a network interface to communicate with the plurality of data repository units 114 where the data repository units 114 hold a set of content data and optionally metadata as opaque data, with each data content item (data item) being associated with a handle (i.e., general category/type values) and each metadata item being associated with an attribute.

In addition, according to an embodiment of the present invention, the storage network 100 considers and evaluates all data as global. In other words any data item from any pipe 105a-105n and 132a-132e may be available for any application running on any application server 102a-102n under any filtering/aggregation conditions. As the amount of data items stored by the storage network 100 increases and the storage network 100 becomes more complex, the ability to customize the services provided to each data stream is of greater importance. In one embodiment of the present invention, the storage network 100 has the ability to identify a type of data item associated with the received data access request and can provide customized processing of data items based on the identified data item type. As described below, the storage network 100 has built-in capabilities to segment the received data item streams and to distribute them to various storage resources (i.e. data repository units 114) according to various factors, such as, but not limited to, the storage network topology, instant capacity and throughput of data repository units 114, and the like. Advantageously, the storage network 100 is enabled to adapt dynamically to the current data traffic conditions thus substantially preventing applications from observing any data storage restrictions. In order to provide the above described capabilities of the distributed QoSt-based storage network 100, each storage node 106, within the storage network 100 may utilize a number of software components (modules). In one embodiment of the present invention, each storage node 106 may include a storage manager 108, a stream processor 112 and a stream controller 110. The storage manager 108 may generally be a software module or application that coordinates and controls storage operations performed by the storage node 106. The storage manager 108 may communicate with all elements of the storage node 106 regarding storage operations. In some embodiments, the storage manager 108 may receive data items via one or more data pipes 105a-105n and may send it to a corresponding stream processor 112. The stream processor 112 may generally be a software module or application that performs a plurality of data management operations using a differentiated treatment of received data items based on a plurality of QoSt attributes. The stream controller 110 may generally be a software module or application that monitors and predicts resource utilization. In addition, the stream controller 110 may be configured to perform corrective actions in response to predicting and/or detecting any degradation of service. Moreover, additional modules may be used in addition to or instead of some of these above enumerated modules.

According to an embodiment of the present invention, stream processing modules (the stream processor 112) may be comprised of additional components, including, but not limited to, receiver components (referred to herein individually as “receiver 120” and collectively as “receiver components 120a-120n” or as “receivers 120”), adaptor components (referred to herein individually as “adaptor 122” and collectively as “adaptor components 122a-122n” or as “adaptors 120”), distributor components (referred to herein individually as “distributor 124” and collectively as “distributor components 124a-124n” or as “distributors 124”), aggregator components (referred to herein individually as “aggregator 126” and collectively as “aggregator components 126a-126n” or as “aggregators 126”), filter components (referred to herein individually as “filter 128” and collectively as “filter components 128a-128n” or as “filters 128”) and extractor components (referred to herein individually as “extractor 130” and collectively as “extractor components 130a-130n” or as “extractors 130”) each of which may produce a data item stream that may be consumed by another component in the storage network 100. In one embodiment access to these data processing functions may be provided via a corresponding API.

The receiver 120 may generally be a software interface that coordinates and controls receipt of new data items provided by the application servers 102. The receiver 120 may classify the incoming data item stream into the category of content based on real-time analysis of the incoming data items in view of the defined plurality of QoSt parameters associated with a corresponding user-configurable policy, as described below. Some examples of user-configurable categories include, but not limited to, user-plane data, control-plane data, audio data, video data, textual data, and the like. The data analysis process may be performed by processing logic that may comprise specialized hardware (e.g., circuitry, dedicated logic, programmable logic, microcode, etc.), specialized software (such as instructions run on a processing device), firmware, or a combination thereof.

The adaptor interface 122 can provide a set of operations for customized data pre and post processing, which may be stream specific or even data item specific, as determined by the application issuing a corresponding data access request. This set of operations may without limitation include data truncation, encryption, decryption, correlation, aggregation, mediation, format conversion, translation into a different language, and the like. As a non-limiting example of format conversion, the adaptor interface 122 may include a function configured to convert data items associated with the data access request between an internal data format suitable for the plurality of data repository units 114 and one or more external data formats specified by any application running on any application server 102. In one embodiment, any combination of the listed data processing operations may be applied to a data item stream received from the receiver interface 120 via an internal link 133a. In an alternative embodiment any application instance running, for example, on the application server 102a upon issuing a data storage request may issue a function call to the adaptor interface 122 directly and may supply data item stream associated with the data storage request via a dedicated pipe 132a.

The distributor component 124 can provide a set of functions that distribute incoming data items among the plurality of data repository units 114a-114z for data item streams that are too large to fit in a single data repository unit 114. In one embodiment, the distributor component 124 may employ an internal policy for segmenting one or more data item streams into a plurality of substreams. The granularity of the segmentation can vary based upon factors such as bandwidth, capacity, activity, etc. of each of the data repository units 114a-114z. In one embodiment, the distributor 124 may view the data repository units 114 as a plurality of corresponding physical storage volumes configured to store data items in a distributed manner. In such embodiment, data can be granulated down to a lowest common denominator (i.e., the bandwidth or capacity of the smallest available physical volume). As previously indicated, the heterogeneous storage network 100 can evolve over time and can include an adequate combination of newly installed and relatively large storage devices and older/smaller storage devices. Even after such an expansion with larger resources, the distributor components 124a-124n of various storage nodes 106a-106n may be configured to ensure that data repository units 114a-114z are utilized in an optimized manner. The extractor interface 130 may also access the plurality of data repository units 114a-114z and may be configured to perform direct data retrieval queries in response to receiving a corresponding data access (data retrieval) request from an application instance running, for example, on first application server 102a. In one embodiment, a local instance of the extractor interface 130a may be used internally to the storage node 106a to retrieve raw data items from both local data repository units 114a-114m and remote data repository units 114n-114z. In such embodiment, various instances of the extractor components 130a-130n may interact with each other to accomplish distributed retrieval of the raw data items. In one embodiment, the extractor may pass the retrieved raw data items to other components such as the adaptor 122, filter 128 and aggregator 126 for further data processing operations. This data transmission may be accomplished via internal links such as links 133b-c, for example. It should be noted that one or more client applications may choose to bypass further data processing functions and may have direct access to raw data items retrieved by the extractor interface 130 via a direct pipe 132e, for example.

The filter component 128 may filter through the raw data items received from the extractor 130 based on either generic data item parameters or application specific parameters. For example, the filter 128 may perform data filtering based on application specific parameters through generalized data tagging available to any client application. In one embodiment, data associated with the data access request may include one or more data streams. Each of the one or more data streams may consist of a plurality of predefined time-ordered items (data items). In order to indicate differentiated treatment upon retrieval for one or more time-ordered items, prior to storing data, a client application may assign one or more tags to at least some of the plurality of stored time-ordered items. Accordingly, the filter component 128 may filter retrieved data based on identified tags in accordance with a user-configurable policy. It should be noted that once an application or a user (such as a storage network administrator) defines a new tag type in a corresponding policy, advantageously, the filter component 128 is enabled to support any application-defined values. It should be further noted that the application issuing a data access request may selectively bypass the aggregator 126 or any other component performing additional data processing functions and may receive filtered data through a dedicated pipe 132d. In some cases one or more applications may choose to perform their own data aggregation.

Other applications may utilize the aggregator interface 126 to aggregate either filtered or raw data items retrieved from the plurality of data repository units 114a-114z. In one embodiment, the aggregator 126 may be optionally responsible for reconstructing the correct order of data items based on time, for example. As shown in FIG. 1, the aggregator 126 may supply the aggregated data back to one or more applications via pipe 132c, for example.

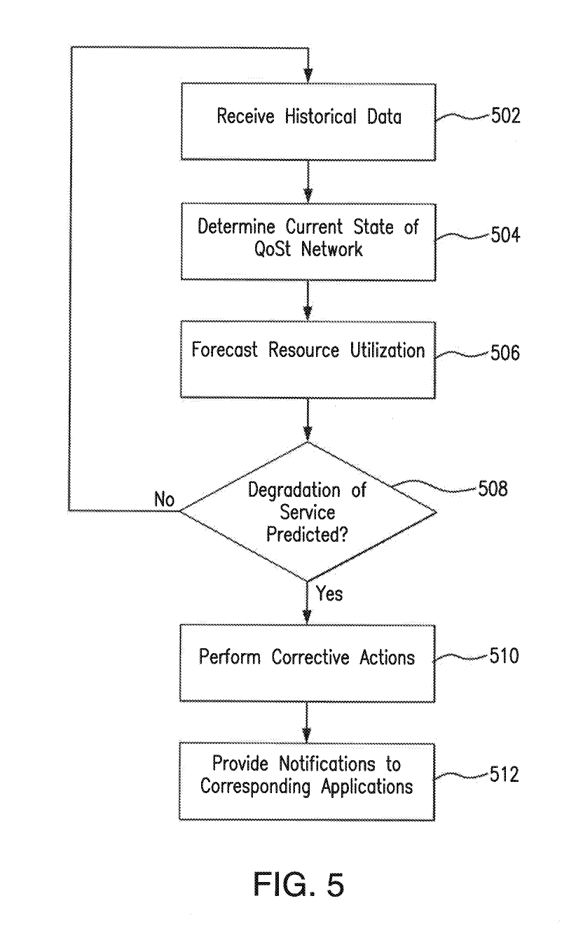

Similarly, stream controller modules (the stream controller 110) may be comprised of additional components, including, but not limited to, monitor components (referred to herein individually as “monitor 116” and collectively as “monitor components 116a-116n” or as “monitors 116”) and analyzer components (referred to herein individually as “analyzer 118” and collectively as “analyzer components 118a-118n” or as “analyzers 118”). The monitor component 116 may be configured to obtain status data concerning the status of the storage network 100 and its components. In one embodiment, the monitor 116 may be responsible for coordinating and dynamically updating data segmentation rules between the receiver components 120a-120n, in response to detecting that new resources such as one or more data repository units 114 or one or more storage nodes 106a-106n have been added to the storage network 100. The analyzer component 118 may be configured to analyze data about the received traffic and may forecast resource utilization over a predetermined forecast period, as discussed below in conjunction with FIG. 5.

As shown in FIG. 1, at least in some embodiments, one or more OAM modules 104 may be connected to the storage network 100, for example, via a dedicated pipe 105b. OAM module 104 may include a user interface and may be used to configure and/or control the above-described components of storage nodes 106a-106n, distribute software or firmware upgrades, etc.

User interface (not shown in FIG. 1) of the OAM module 104 may be configured to present current state of QoSt network and to provide degradation of service notifications and other relevant information to the end-users. In one embodiment, the OAM module 104 may include two different components—storage OAM component 103 which interfaces directly with the storage network 100 via pipe 105b and application OAM component 101 which interfaces directly with application servers 102a-102n via pipes 105c and 105d. It should be noted that the application OAM component 101 need not be aware of storage network's 100 configuration in order to make use of QoSt capabilities.

According to an embodiment of the present invention, storage nodes 106a-106n illustrated in FIG. 1 can be flexibly distributed on heterogeneous hardware platforms and then directly interconnected as needed. Storage nodes 106 can also be grouped into “node groups” which are collocated depending on the total capacity/performance requirements requested by various applications. Furthermore, all software components 108-112 may be entirely implemented on each storage node 106a-106n, or the software components 108-112 may be implemented in a distributed computing environment on multiple types of storage nodes running the same or different operating systems and that communicate and interact with each other over the storage network 100. If a function provided by a specific software module/component is not available on a given storage node 106, then data traffic can be transparently re-routed to storage nodes 106 having that capability.

Resources of storage network 100 may generally be susceptible to being adapted to serve a given demand or need, for example by providing additional processing or storage resources. However, because the demand placed on the storage network 100 can vary with time, it is necessary to manage the resources that are available. If the available resources are insufficient for a given demand, performance of the storage network 100 may be compromised. Conversely, if the available storage network 100 resources greatly exceed the demand, the resources may be wasted, resulting in unnecessary costs or lost opportunity in which the resources could have been applied to other needs. Burst activity, in which the demand placed on resources, may increase very rapidly, for example, increasing many multiples or orders of magnitude over the course of minutes or a few hours, can create many challenges to storage network 100 management. In order to meet the changing needs in the storage network illustrated in FIG. 1 various scaling strategies may be implemented. The scaling strategy may include vertical scaling and horizontal scaling. Advantageously, by allowing storage nodes 106a-106n with the same logical function/level in the hierarchy to collaborate in order to perform a global, distributed service, the horizontal scaling can be achieved fairly easily.

FIG. 2 is a block diagram illustrating a further view of QoSt aspect of ultra-high throughput storage management architecture, in accordance with an illustrative embodiment of the present invention. According to an embodiment of the present invention, storage management architecture can be implemented as a policy based storage management framework. One or more policies associated with one or more applications can specify how data having certain characteristics will be managed throughout its lifecycle. Generally, a policy is a “condition-action” tuple. The condition part specifies an event or state that acts as trigger(s) for the action part to be executed. The condition can reflect an attribute value, which may include, but is not limited to, data repository units' 114 capacity changes, short lived traffic bursts, network topology changes, and the like. The action(s) associated with the occurrence of one or more conditions may involve the execution of specific procedures or functions, the raising of other conditions, and/or the setting of other attributes to particular values. In this last case, an action may thus establish triggers for other actions.

FIG. 2 illustrates a conceptual view of how policy based management can be applied to the QoSt based network 100. The storage network 100 includes numerous storage nodes 106 linking the customer applications 201a-201n to one or more data repository units 114, such as one or more interconnected disk drives configured as a Redundant Array of Independent Disks (RAID), Just a Bunch of Disks (JBOD), Direct Access Storage Device (DASD), etc. Typically, a customer will pursue a service level agreement (SLA) with the storage service provider concerning the criteria under which network storage resources are provided, such as the storage capacity, network throughput, I/O response time, I/O operations per second, and other performance criteria under which the storage resources will be provided. In certain situations, multiple customers with different levels of requirements specified in their service level agreements will share the same storage resources. This requires that the storage service provider monitor and manage the storage resources to ensure that the different customer requirements specified in the different service level agreements are satisfied. For the purpose of simplicity of illustration only one storage node 106a is shown within the storage network 100, it being understood that the storage network 100 may include a plurality of the same or different types of storage nodes 106.

As shown in FIG. 2, the storage node 106 may be configured to provide data storage and retrieval service to one or more applications 201a-201n configured for execution on one or more application servers 102a-102n. Each application 201a-201n may include an API 202a-202n which may support communication between applications 201a-201n and storage nodes, such as storage node 106. API 202 may support data access requests, typically data storage and data retrieval requests, from applications 201 running on the application servers 102a-102n. From an application point of view, reading or writing information from/to the storage network 100 may be transparent. For example, since, according to various embodiments of the present invention, applications 201a-201n read or write information from/to data pipes 105a-105n, preferably, these applications 201a-201n are not particularly concerned with a type of storage system connected to the other end of the pipe. In fact, from their point of view the storage system does not necessarily comprise a distributed data storage network but may include any other type of storage solution, for instance a file server or a hard drive.

In order to achieve the above-mentioned objectives, such as satisfying performance requirements, achieving transparency and dynamic adaptation of changing demand of storage resources, according to an embodiment of the present invention, the transparently-scalable storage network 100 may utilize a storage policy concept. Storage policies 204a-204n may be used to control the manner in which a particular task/application 201 accesses or consumes storage resources as data repository units 114, or to prioritize that task/application relative to others. As used herein, storage policies 204a-204n concern an application's requirements on the data that it generates or uses—and, based at least on such policies, various software components of storage nodes 106 make a decision related to a choice of data repository units 114 on which the application provided data should reside. For instance, an application 201a may have specific requirements for the speed and format of data access, or for recoverability of the data in the event of an outage. The speed of access may be a consequence of needing to achieve a certain transaction rate, and may potentially vary during application execution. Hence, different applications 201a-201n may require different access rates when accessing the same data, or may require different types of I/O (e.g. read vs. write, sequential vs. random). Thus, one of the objectives of the QoSt based storage network 100 is to achieve differentiated treatment of data.

To implement the differentiated treatment of data each of the storage policies 204a-204n may comprise a plurality of orthogonal QoSt attributes. According to an embodiment of the present invention, the QoSt attributes may include, but not limited to, data priority value, data retention time value, data robustness value, I/O performance requirement values, client priority value, storage category value, data security class, and the like. However, more generally, QoSt attributes could be a defined set of attributes that consider other properties of various data contents types and/or other properties that may be relevant to various applications 102a-102n. According to an embodiment of the present invention, this set of QoSt attributes may be dynamically configurable by an end user, for example via the OAM node 104, and having substantially immediate effect on the storage network 100 and storage policies 204a-204n.

The client priority represents a relative importance of the client application 201 that issues a data storage/retrieval request to the storage network 100 with respect to a set of all applications 201a-201n that are currently communicating with the storage network 100. Additionally, the different types of data may be prioritized. For example, a data priority value may be assigned for each type of data indicative of the priority for that type of data. The priorities may be predetermined. Those skilled in the art will understand that any range of priority values may be used in accordance with embodiments of the present invention, but for illustrative purposes as used herein, priorities range from 7 (lowest) to 0 (highest).

According to an embodiment of the present invention, retention management capabilities may be controlled within the disclosed storage network 100, wherein applications 201a-201n have the ability to set a given dataset(e.g., a data stream) for retention for a particular retention period by assigning corresponding retention date(s) in a data retention time attribute of the given data stream. In one embodiment, the data retention time value may represent the minimum and maximum amount of time that the user requires the particular data stream to be retained in storage. As used herein, the data robustness value indicates the amount of redundancy/robustness required for a particular data stream, such as, but not limited to, storing data in volumes of different RAID types, a number of replications required, geographic redundancy, etc. The I/O performance requirement values associated with a particular data stream represent the relative speed at which this particular data stream needs to be accessible to the requesting application. Accordingly, storage manager component 108 (shown in FIG. 1) may assign I/O performance sensitive data types to higher bandwidth and lower latency paths within the storage network 100 such that the I/O performance related QoSt requirements for the data type are satisfied.

According to an embodiment of the present invention, the storage category value represents the type of physical storage requested for the data. This attribute controls which data repository unit 114 will be selected from a heterogeneous pool of physical storage devices 114a-114z. As discussed above, different types of physical storage devices may include, but are not limited to flash memory, solid-state drives (SSDs), hard disk drives (HDDs), etc. In addition, this attribute may indicate whether the data stream should be stored in directly attached or remotely located storage devices. According to an embodiment of the present invention, the data security class attribute may be used to control security mechanism within the QoSt storage network 100. The data security class indicates the required security level for a given data stream. This attribute may affect, for example, the level of provided data encryption and/or the selected type/location of the physical storage for the given data stream.

Referring back to FIG. 2, it should be understood that many applications 201a-201n may be able to define how critical each data type is for them, thus making the conventional storage contract more flexible on a case-by-case basis. In other words, the QoSt attributes described above represent a novel refinement of the conventional fixed SLA. As previously indicated, one or more relevant QoSt attribute values may be contained within the storage policies 204a-204n that may be provided to storage interface 205 of storage nodes 106 by each application 201a-201n being served by the storage network 100. According to an embodiment of the present invention, in addition to storage policies 204a-204n, the disclosed storage interface 205 may employ a variety of internal policies including, but not limited to, traffic management policy, congestion control policy, OAM policy, and the like. These policies may be controlled by various storage interface components, such as, traffic policy manager 206, congestion policy manger 208, OAM policy manager 210, and the like. It is noted that the storage interface 205 may be configured to dynamically create/modify the aforementioned policies based, at least in part, on the aggregated information provided by the plurality of received storage policies 204a-204n and based on the dynamically observed traffic/storage conditions within the storage network 100. According to various embodiments of the present invention, a traffic management policy may be directed to, for example, dynamic splitting, re-routing and/or aggregation of traffic according to the time-dependent observed traffic patterns. A congestion control policy may be directed to, for example, priority-based handling of traffic during periods of resource shortages, such as storage capacity exhaustion, processing power exhaustion, link bandwidth overflow, and the like. An OAM policy may be related to, for example, to QoSt-specific OAM functionality, such as specific configuration, maintenance, alarming, statistical reporting and other functionality enabling differentiated handling of storage data.

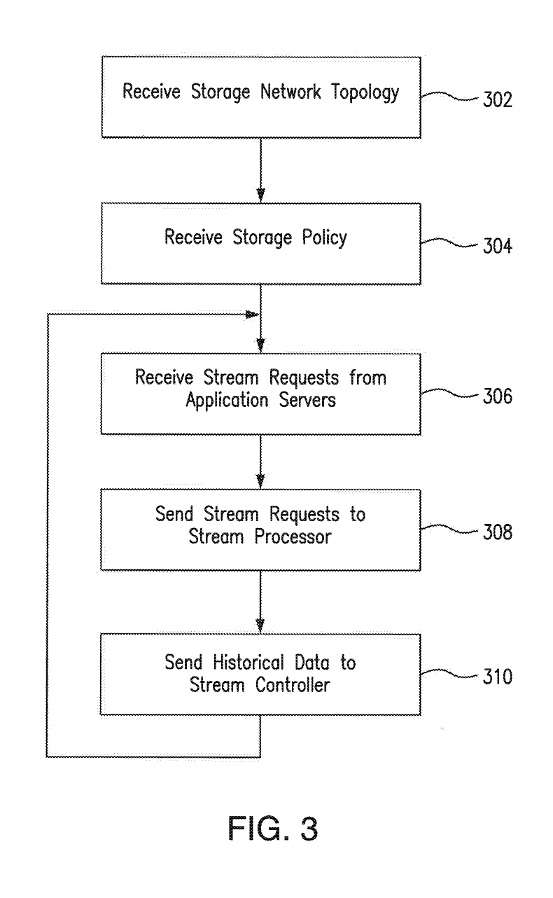

FIGS. 3, 4 and 5 are flowcharts of operational steps of the storage manager module 108, stream processor module 112 and stream controller module 110 of FIG. 1, in accordance with exemplary embodiments of the present invention. Before turning to descriptions of FIGS. 3, 4 and 5, it is noted that the flow diagrams shown therein are described, by way of example, with reference to components shown in FIGS. 1-2, although these operational steps may be carried out in any system and are not limited to the scenario shown in the aforementioned figures. Additionally, the flow diagrams in FIGS. 3, 4 and 5 show examples in which operational steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step. In some embodiments, one or more additional steps may be included.

Starting with FIG. 3, FIG. 3 is a flowchart of operational steps of the storage manager module of FIG. 1. The storage manager 108 may generally be a software module or application that coordinates and controls storage operations performed by one or more storage nodes 106. At 302, the storage manager 108 preferably receives current storage network topology information. Obtaining current network topology from any node within the storage network 100 can be achieved in a number of ways. For example, the storage network 100 can be configured such that every storage node 106a-106n within the network has information about the current network topology. Alternatively, in another example, only a select number of storage nodes (e.g., first storage node 106a) within the storage network 100 may have information about the current storage network topology, where such storage nodes can share this information with other storage nodes such that every storage node 106a-106n within the storage network 100 is capable of providing current storage network topology information based upon a need/request for such information. A domain on the network topology can also be set, e.g., to limit the information obtained from the query to a specified number of data repository units 114 or a limited range (e.g., a limited number of hops) in relation to the requesting storage node 106a. Current topology information can be provided based upon constraints or limits established by the requesting storage node 106. For example, the storage manager 108 running on the requesting storage node 106 may be interested in a particular data repository unit 114 or set of repository units (e.g., repository units 114n-114z) within the storage network 100 instead of an entire storage network 100 domain.

At 304, the storage manager 108 preferably receives one or more storage policies 204a-204n from one or more applications 201a-201n. As previously indicated, each storage policy 204a-204n may comprise a plurality of orthogonal QoSt attributes. As used herein, storage policies 204a-204n concern an application's per stream requirements on the data that it generates or uses. These QoSt attributes facilitate the differentiated treatment of data streams contingent upon at least different types of data. Thus, storage policies 204a-204n may be used by the storage manager 108 and other modules/components to control the manner in which a particular application accesses or consumes storage resources at data repository units 114, or to prioritize that data stream relative to others.

In an embodiment of the present invention, once the storage manager 108 processes and aggregates information related to storage policies, at 306, the storage manager 108 may start receiving a plurality of data stream requests from one or more applications 201a-201n running on one or more application servers 102a-102n. According to an embodiment of the present invention, each stream request may comprise one or more streams of raw data items. At 308, the storage manager 108 may send stream requests, i.e. data access requests, to stream processor 112 for further processing. According to an embodiment of the present invention, at 310, the storage manager 108 may send information related to received data streams to the stream controller 110, which may be configured to monitor storage network status and to detect trends related to the received data or data types. Upon transmitting relevant data, the storage manager 108 preferably continues to perform steps 306-310 in an iterative manner.

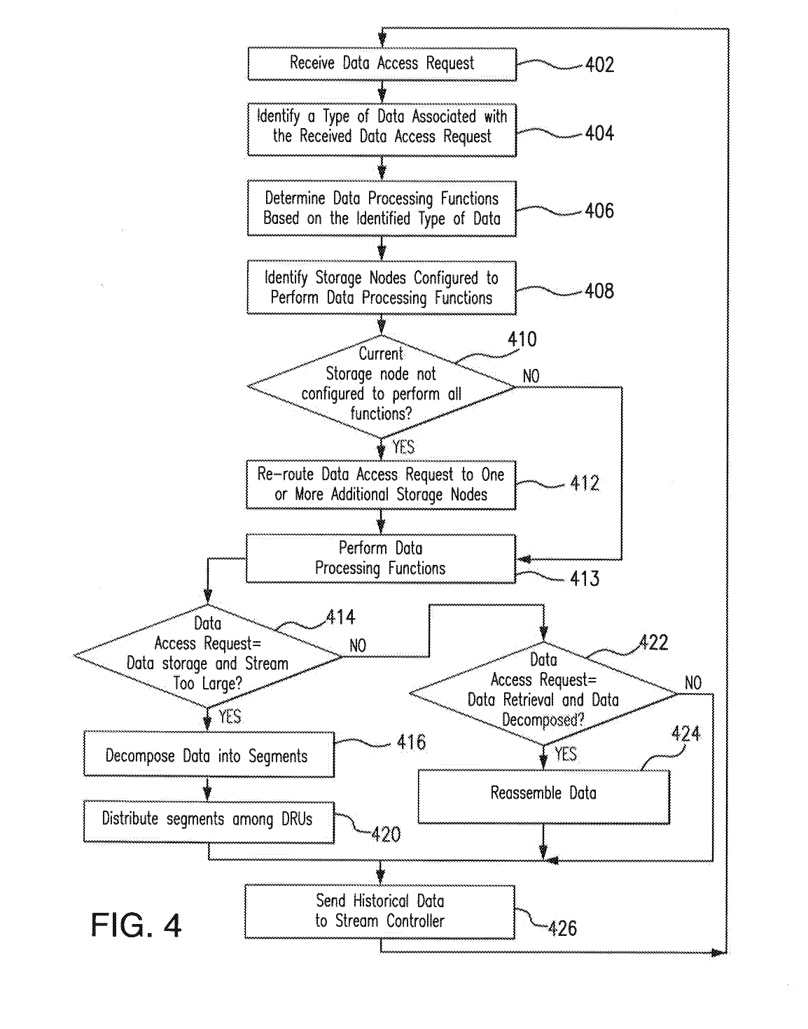

FIG. 4 is a flowchart of operational steps of the stream processor module 112 of FIG. 1, in accordance with an illustrative embodiment of the present invention. The stream processor 112 may generally be a software module or application that performs a plurality of data management operations using a differentiated treatment of received data based on a plurality of QoSt attributes. According to an embodiment of the present invention, one or more applications 201a-201n may send one or more data access requests to the stream processor 112. In an alternative embodiment, data access requests may be initially processed by the storage manager 108, as described above with respect to FIG. 3, which in turn may pass all data access requests to the stream processor 112. A data access request includes one or more of a data storage request and a data retrieval request. At 402, the stream processor 112 preferably receives and processes the one or more data access requests.

Various embodiments the present invention contemplate user plane packets, control plane packets, video packets, audio packets, web pages, etc., as various data item types. According to various embodiments of the present invention, the item type is the atomic unit of data exchange between the client applications and the storage network 100. Since all types of data are treated in accordance with a user-configurable storage policies 204a-204n, new item types and even new applications can be readily added to extend the capabilities of the storage network 100 without making any changes to the corresponding code of the storage network 100. According to an embodiment of the present invention each data access request may be associated with one or more streams of raw data items. The receiver component 120 of the stream processor 112 may be configured to examine and classify the received data items at step 404. The receiver 120 may classify the data item streams based on, for example, data item types detected within the received streams of data items. In one embodiment, exemplary classifications may be somewhat broad, such as, but not limited to, a stream of user plane data and a stream of control plane data. In another embodiment, data items may be classified using more specific categories, such as, but not limited to, streams of video data, audio data, and plain text data, etc. Generally, classification of data item streams depends on types of applications being serviced by the storage network 100. It should be appreciated that the receiver component 120 of the stream processor 112 can detect the categories of traffic based on a very large number of classification criteria. The stream processor 112 may create a data structure for each classification. This step may further involve identifying a storage policy 204 associated with each data item stream from which the received data item is collected. In an alternative embodiment, this step of identifying and classifying data types may be performed by the storage manager 108, if the storage manager 108 is configured to evaluate all incoming data access requests prior to forwarding them to the stream processor 112.

As an example of dynamic adaptation of the storage network 100 to new data item types, assume that at deployment time differentiated treatment was defined only for two types of data items, namely, user plane packets and control plane packets. However, post-deployment one of the client applications may request a differentiated treatment for all incoming video traffic within the user plane data type. Accordingly, the client application may define a new data item type (e.g., data item type=“video”) in a corresponding storage policy 204 along with data processing requirements using, for example, a plurality of QoSt attributes. For instance, video traffic may be assigned a higher priority level. Once the storage policy 204 gets updated, various components of the storage network 100 dynamically start handling incoming video traffic with higher priority in comparison to other classified data item types. The stream processor 112 may further evaluate the received data access request in view of restrictions and requirements included in various storage policies 204. In other words, the stream processor 112 may be configured to adapt to the client applications' demands and to optimize its storage/retrieval functionality and resources accordingly.

Various embodiments of the present invention provide a simple, open-ended architecture for organizing the data item types that are rapidly accessible, and are relatively easy to augment or modify to meet the requirements of many different applications. Thus, to meet the requirements of many different client applications 201a-201n, different types of data items may require different processing. Accordingly, at 406, the stream processor 112 may be configured to identify one or more data processing functions as requested to be carried out on the data item stream associated with the corresponding data access request based on the identified data item type. These data processing operations may without limitation include data truncation, encryption, decryption, correlation, aggregation, mediation, format conversion, translation into a different language, and the like.

Due to the distributed nature of disclosed storage network 100 architecture, the plurality of data processing functions may be distributed among various storage nodes 106a-106n. Accordingly, at 408, the stream processor 112 preferably identifies one or more storage nodes 106a-106n configured to perform the desired data processing operations. In other words, at 408, the stream processor 112 may determine which of the plurality of storage nodes 106a-106n include adaptor components 122a-122n described above. Advantageously, embodiments of the present invention provide techniques for performing a desired data processing operation in parallel using multiple adaptor components 122a-122n. In other words, the storage nodes 106a-106n may perform multiple collective data processing operations to effect the desired data processing operation.

At 410, the stream processor 112 may optionally determine whether a given storage node 106 is configured to perform all of the requested data processing operations. In other words if the first storage node 106a has received a data access request, the stream processor 112a running on that node may determine whether an adaptor component 122 is local to the first storage node 106a and whether that local adaptor 122a is configured to perform all of the requested data processing functions. The advantage of this determination is that the stream processor 112 can do an overall optimization of data processing, data repository units' 114 management and data accesses for all client applications 201a-201n by ensuring locality of data processing, if such functionality is available. In response to determining that the given storage node 106 is not capable of carrying out one or more of the desired data processing functions (step 410, yes branch), at 412, the stream processor 112 may re-route the received data access request and/or data streams/items associated with the data access request to other storage nodes identified at step 408 enabled to perform the desired data processing operation. Next, at 413, the adaptor interface 122 of the stream processor 112 may perform one or more desired data processing operations.

It is noted that data repository units 114a-114z shown in FIGS. 1 and 2 may comprise any number of different forms of storage. Still further, each of the data repository units 114a-114z need not be limited to a single memory structure. Rather, the data repository unit 114 may include a number of separate storage devices of the same type (e.g., all flash memory) and/or separate storage devices of different types (e.g., one or more flash memory units and one or more hard disk drives). In an embodiment of the present invention, one or more data repository units 114 may have variable logical storage block sizes. Variable logical storage block sizes allow optimization of each data repository unit 114 for reading and writing different types of data items since applications tend to access different data item types in different manners. For example, data items associated with a video stream may be accessed in large sections at a time. As such, it may be more efficient for the stream processor 112 to use a large logical storage block size to organize such video media data for subsequent access by, for example, a video player application.

Likewise, data items associated with an audio stream may be accessed in large sections at a time, although such audio media sections may be smaller than the corresponding video media data sections. Accordingly, it may be efficient for the stream processor 112 to use a medium-sized logical storage block structure to organize audio data. Data items associated with other data item types may be efficiently handled by the stream processor 112 using cluster-sized logical storage blocks. Accordingly, the stream processor 112 may substantially constantly keep track of free storage available in the storage network 100.

Referring back to FIG. 4, at 414, the stream processor 112 may start processing the received data access request by first determining whether it is a data storage request and may determine if any of the incoming streams are too large to fit in one of the available data repository units 114. If so (step 414, yes branch), at 416, the distributor component 124 of the stream processor 112 may decompose such incoming stream into a plurality of segments (sub-streams). It is noted that this plurality of segments could be distributed among multiple data repository units 114 in accordance with current resource conditions, such as availability parameters. These availability parameters may include, by way of example and without limitation, parameters corresponding to each of the plurality of data repository units 114 and indicative of the remaining data throughput and the remaining storage capacity of a given data repository unit 114. In some cases, the distributor component 124 may split the incoming data item streams based on the availability parameters. In other words, the distributor component 124 may distribute the plurality of data segments among the plurality of data repository units 114, so that each of the plurality of data repository units 114 selected for storing a particular data segment has sufficient remaining storage capacity and sufficient remaining data throughput to accommodate this particular data segment.

According to an embodiment of the present invention, at 420, the distributor component 124 of the stream processor 112 may distribute the decomposed data items among the plurality of data repository units 114. It is noted that, the distributor component 124 preferably generates and stores segment information for the plurality of data segments related to the decomposed data items associated with the data storage request. In an embodiment of the present invention the generated segment information may contain information corresponding to the decomposed data segments indicative of which data repository units 114a-114z contain which type of data items and indicative of corresponding time intervals if the stored data represents a plurality of predefined time-ordered data items. In various embodiments of the present invention, the distributor component 124 may be configured to dynamically adapt to one or more configuration changes, such as network topology changes related to the data repository units 114. For example, the distributor component 124 may be enabled to redistribute data items among the units in response to detecting that a new unit has been added or an existing unit has been removed to/from the plurality of data repository units 114a-114z.

Otherwise, in response to determining that the received data access request does not constitute a data storage request (step 414, no branch), at 422, the stream processor 112 may determine whether the received data access request is a data retrieval request and whether the data retrieval request is associated with data items that have been previously distributed among data repository units 114. If so (step 422, yes branch), at 424, the aggregator component 124 of the stream processor 112 may reassemble the extracted raw data items satisfying the data retrieval request based, at least in part, on the segment information generated by the distributor component 124. For example, if the received data retrieval request submitted by one or more client applications specified a time interval of interest, during reassembly, the aggregator component 124 may only aggregate raw data items corresponding to the specified time interval of interest. However, the aggregation operation is not limited to any specific data item attributes, such as time interval. The aggregation criteria may be, by way of example and not limitation, a common customer identifier and a common ship-to address, similar ship-by dates, common carrier and any other suitable data retrieval criteria, which may be specified by one or more client applications in the received data access (retrieval) requests. It is noted that at least in some embodiments, one or more client applications 201a-201n may select to carry out the aggregation operation on the extracted raw data items themselves. It is further noted that an optional filtering step may be performed by the filter interface 128 of the stream processor 112 in accordance with a corresponding storage policy 204.

At 426, the stream processor 112 may send various historical data related at least to data access requests to the stream controller 110. Such information preferably indicates the quantity of free space remaining in the storage network 100. Upon transmitting historical data, the stream processor 112 preferably continues to selectively perform steps 402-426 in an iterative manner.

FIG. 5 is a flowchart of operational steps of the stream controller module of FIG. 1, in accordance with an illustrative embodiment of the present invention. The stream controller 110 may generally be a software module or application that monitors and predicts resource utilization. In addition, the stream controller 110 may be configured to perform corrective actions in response to predicting and/or detecting any degradation of service.

At 502, the monitor component 116 of the stream controller 110 may monitor and aggregate usage pattern data received from other software components, such as, but not limited to, the storage manager 108 and the stream processor 112. By aggregating information about various storage related operations and various usage patterns, the analyzer component 118 of the stream controller 110 may perform real time analysis of incoming data traffic. Accordingly, at 504, the analyzer 118 determines current state of the storage network 100 based on said real time analysis. Current state of the storage network 100 includes at least information related to current states of individual data repository units 114a-z, such as, but not limited to remaining capacity and bandwidth of each of the plurality of data repository units 114a-z. According to an embodiment of the present invention, the analyzer 118 may at least periodically store these availability parameters into a central repository (not shown), In addition, in response to detecting network topology changes discussed above with respect to FIG. 4, the analyzer 118 may accordingly update the availability parameters stored in the central repository. In some embodiments, the analyzer 118 may store information related to current state of the storage network 100 as network generated data items. However, it is noted that client applications may also have access to these data items in order to get additional information related to various subsets of data items. Next, at 506, the analyzer 118 may forecast resource utilization over a predetermined forecast period. For example, the analyzer 118 may forecast resource utilization based at least in part on associated historical storage and computing resource load patterns. The historical resource load patterns may be with respect to the distributed storage service as a whole, particular data repository units 114a-z, particular data item streams and/or a particular user of the data storage service (i.e., particular application 201). The analyzer 118 may further take into account the incoming data traffic as analyzed by the storage manager 108.

At 508, the stream controller 110 may determine whether the degradation of service is predicted. Degradation of service may include an indication of one or more degraded service level parameters, such as, but not limited to, increasing storage network congestion, exhaustion of available storage capacity, among many others. In response to detecting no degradation of service (step 508, no branch), the stream controller 110 may return back to step 502 to continue periodically collecting latest storage related information and monitoring current state of the storage network 100.

According to an embodiment of the present invention, at 510, in response to detecting or predicting any degradation of service, the stream controller 110 may cooperate with other software components, such as storage manager 108 and stream processor 112 to perform one or more corrective actions. For example, in response to detecting increasing storage network congestion, the stream controller 110 may re-allocate the incoming data item streams between processing storage nodes 106a-106n and/or may re-allocate the incoming data item streams between physical data repository units 114a-z based on their forecasted utilization. According to an embodiment of the present invention, a plurality of stream controllers 110 running on one or more storage nodes 106a-106n may be configured to perform a distributed decision making procedure related to reassignment of incoming data item streams. It is noted that if the stream controller 110 determines that considering the current state of the storage network 100 it is not physically possible to resolve the congestion by re-allocating data item streams such that all storage parameters specified by QoSt attributes are satisfied, the stream controller 110 may decide to store information contained in the incoming data item streams in order of precedence indicated by the QoSt data priority value described above. In other words, the stream controller 110 is configured to dynamically adapt to the current storage network 100 conditions and to make intelligent decision to save the most important data first and possibly discard the least important data. As another non-limiting example, in the situation where the stream controller 110 decides that it is not possible to resolve the storage capacity exhaustion problem by reallocating data item streams between the available data repository units 114 and satisfying all storage parameters, the stream controller 110 may make a decision to reduce the retention time for the received and/or already stored data items in accordance with the precedence indicated by the QoSt data priority value associated with each data item stream. As yet another example, the stream controller 110 may discard or re-locate data items having lower priority from a particular data repository unit 114 in order to accommodate incoming data items from data item streams having higher priority.

According to an embodiment of the present invention, at 512, the stream controller 110 may provide notifications to various applications 201a-201n being served by the storage network 100, wherein each notification may provide information related to current state of the storage network 100 and/or information indicative of taken corrective action. In one embodiment, the stream controller 110 may communicate directly with the applications 201a-201n via the pre-configured API 202a-202n. In other embodiments, the stream controller 110 may employ alarm events, interrupts and other mechanisms well known in the art to communicate relevant information to a plurality of applications 201. In response, rather than adjusting their performance, the plurality of applications 201 may present information related to system capacity/performance (i.e., alarms and statistics) to end users, such as system administrators, network technicians, and the like, who may take one or more corrective actions, if necessary, as described below. In yet another embodiment, the stream controller 110 may provide various storage service related notifications to the OAM node 104. It should be noted that values of the various QoSt attributes are not necessarily remain fixed in time. Their values can be modified after deployment, because the storage network 100 is capable of adapting to them in a dynamic manner. By providing early warnings (via the disclosed notification techniques) based on user-defined criteria, the stream controller 110 allows system administrators and/or technicians supporting the storage network 100 take effective measures before service degradation occurs. Such measures may include, but are not limited to, fine-tuning individual applications 201, reconfiguration of individual storage policies 204a-204n and/or internal policies, such as traffic management policy, congestion control policy, OAM policy, performing storage scaling (either horizontal or vertical), among other measures.

In summary, various embodiments of the present invention describe a novel storage management approach that offers a cost-effective network storage solution capable of receiving, processing and storing large amounts of data without adding a significant overhead. Advantageously, the disclosed data management platform employs an elaborate QoSt supporting framework, which is based primarily on processing rules that are consistent with the full set of data attributes defined by the interface. In another aspect, robustness of data storage system is provided to users through highly flexible software modules that function in an efficient way that is transparent to an application using the disclosed storage network. Various embodiments of the present invention introduce a new approach aimed at customizing substantially all general functions of the data management platform through well-defined API function calls.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

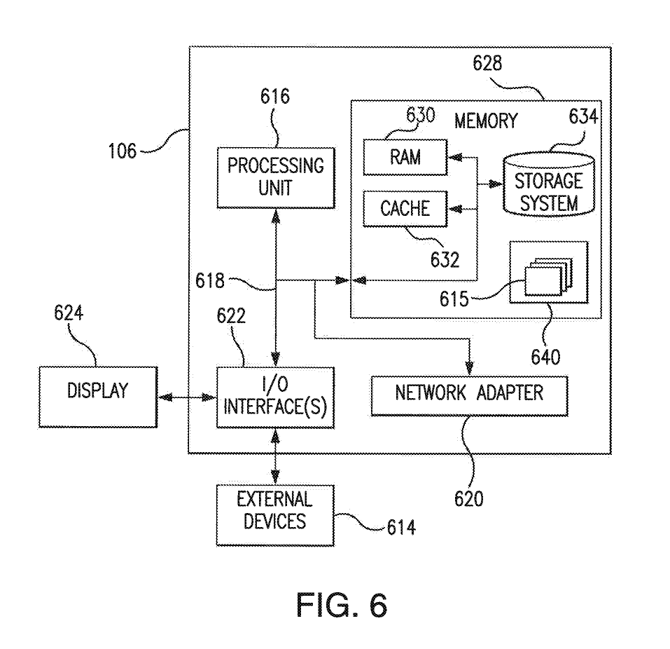

Embodiments of a transparently-scalable, ultra-high throughput QoSt based storage management framework may be implemented or executed by storage nodes comprising one or more computer systems. One such storage node 106 is illustrated in FIG. 6. In various embodiments, storage node 106 may be a server, a mainframe computer system, a workstation, a network computer, a desktop computer, a laptop, or the like.

Storage node 106 is only one example of a suitable system and is not intended to suggest any limitation as to the scope of use or functionality of embodiments of the invention described herein. Regardless, storage node 106 is capable of being implemented and/or performing any of the functionality set forth hereinabove.

Storage node 106 may be described in the general context of computer system-executable instructions, such as program modules, being executed by a computer system. Generally, program modules may include routines, programs, objects, components, logic, data structures, and so on that perform particular tasks or implement particular abstract data types. Storage node 106 may be practiced in distributed data processing environments where tasks are performed by remote processing devices that are linked through a communications network. In a distributed data processing environment, program modules may be located in both local and remote computer system storage media including memory storage devices.

Storage node 106 is shown in FIG. 6 in the form of a general-purpose computing device. The components of storage node 106 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Storage node 106 typically includes a variety of computer system readable media. Such media may be any available media that is accessible by storage node 106, and it includes both volatile and non-volatile media, removable and non-removable media.

System memory 628 can include computer system readable media in the form of volatile memory, such as random access memory (RAM) 630 and/or cache memory 632. Storage node 106 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 615, such as storage manager 108, stream controller 110 and stream processor 112, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 615 generally carry out the functions and/or methodologies of embodiments of the invention as described herein.

Storage node 106 may also communicate with one or more external devices 614 such as a keyboard, a pointing device, a display 624, etc.; one or more devices that enable a user to interact with storage node 106; and/or any devices (e.g., network card, modem, etc.) that enable storage node 106 to communicate with one or more other computing devices. Such communication can occur via Input/Output (I/O) interfaces 622. Still yet, storage node 106 can communicate with one or more networks such as a local area network (LAN), a general wide area network (WAN), and/or a public network (e.g., the Internet) via network adapter 620. As depicted, network adapter 620 communicates with the other components of storage node 106 via bus 618. It should be understood that although not shown, other hardware and/or software components could be used in conjunction with storage node 106. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A data storage system in a high-capacity network, the system comprising:
a plurality of storage nodes configured to receive data access requests from one or more client applications;
a plurality of data processing functions associated with the plurality of storage nodes, wherein each of the plurality of data processing functions is configured to be performed by one or more of the plurality of storage nodes; and
a plurality of data repository units operatively coupled to the plurality of storage nodes, the plurality of data repository units configured to store and retrieve data items associated with the received data access requests,
wherein the plurality of storage nodes is further configured to analyze and categorize data item streams associated with the received data access requests, decompose the categorized data item streams into a plurality of data segments, determine availability parameters associated with each of the plurality of data repository units and distribute the plurality of data segments among the plurality of data repository units based on a user-configurable policy associated with identified data item category and based on the determined availability parameters associated with each of the plurality of data repository units.

2. The data storage system of claim 1, wherein the plurality of storage nodes is further configured to monitor usage patterns of the plurality of data repository units operatively coupled to the one or more storage nodes.

3. The data storage system of claim 2, wherein the plurality of storage nodes is further configured to forecast utilization of the plurality of data repository units for a predetermined forecast period based on historical trends of the usage patterns related to the plurality of data repository units and wherein the plurality of storage nodes distributes the plurality of data segments among the plurality of data repository units based on the forecasted utilization of the plurality of data repository units.

4. The data storage system of claim 1, wherein data items associated with the data access requests comprises one or more data item streams, each of the one or more data item streams comprising a plurality of predefined time-ordered items and wherein the plurality of data processing functions includes a filtering function configured to filter at least some of the plurality of time-ordered items based on one or more tags assigned to at least one of the plurality of predefined time-ordered items by the client applications to indicate differentiated processing in accordance with the user-configurable policy associated with the identified data item category.

5. The data storage system of claim 1, wherein the plurality of data processing functions comprises at least two different process levels distributed among the one or more storage nodes.

6. The data storage system of claim 1, wherein the plurality of data processing functions includes a converter function configured to convert data items associated with the data access requests between an internal data format suitable for the plurality of data repository units and one or more external data formats specified by the one or more client applications.

7. The data storage system of claim 1, wherein the availability parameters comprise at least parameters indicative of the remaining data throughput and the remaining storage capacity associated with each of the plurality of data repository units.

8. The data storage system of claim 2, wherein the plurality of storage nodes configured to monitor usage patterns of the plurality of data repository units is further configured to store the availability parameters associated with each of the plurality of data repository units into a central repository.

9. The data storage system of claim 8, wherein the plurality of storage nodes is further configured to dynamically adapt to one or more configuration changes related to the plurality of data repository units and configured to update the availability parameters stored in the central repository in response to detecting the one or more configuration changes.

10. The data storage system of claim 1, wherein the received data access requests include a data retrieval request specifying a time interval of interest and wherein the plurality of storage nodes is configured to retrieve and assemble data items corresponding to the specified time interval of interest.

11. The data storage system of claim 7, wherein the plurality of storage nodes is configured to distribute the plurality of data segments among the plurality of data repository units so that each of the plurality of data repository units selected for storing a particular data segment under consideration has sufficient remaining storage capacity to store the particular data segment under consideration.

12. The data storage system of claim 7, wherein the plurality of storage nodes is configured to distribute the plurality of data segments among the plurality of data repository units so that each of the plurality of data repository units selected for storing a particular data segment under consideration has sufficient remaining data throughput to store the particular data segment under consideration.

13. The data storage system of claim 1, wherein the plurality of data processing functions includes an aggregation function configured to aggregate data items retrieved from the plurality of data repository units based on a criteria specified in a corresponding data access request by the one or more client applications.

14. The data storage system of claim 1, wherein the plurality of data processing functions includes an extractor function configured to retrieve raw data items from one or more of the plurality of data repository units.

15. The data storage system of claim 1, wherein the plurality of storage nodes is configured to determine one or more data processing functions to process the received data access request based on the categorized data items associated with the received data access request and configured to re-route the received data access requests to one or more storage nodes configured to perform the determined one or more data processing functions.

16. The data storage system of claim 9, wherein the one or more configuration changes includes an addition of a new data repository unit to the plurality of data repository units.

17. The data storage system of claim 9, wherein the one or more configuration changes includes a removal of a data repository unit from the plurality of data repository units.

18. A computer program product for storing and retrieving data in a high-capacity network having a plurality of storage nodes, the computer program product comprising:
one or more computer-readable storage devices and a plurality of program instructions stored on at least one of the one or more computer-readable storage devices, the plurality of program instructions comprising:
program instructions to receive data access requests from one or more client applications;
program instructions to analyze and categorize data items associated with the received data access requests;
program instructions to decompose the categorized data item streams into a plurality of data segments;
program instructions to determine availability parameters associated with each of a plurality of data repository units operatively coupled to the plurality of storage nodes; and
program instructions to distribute the plurality of data segments among the plurality of data repository units based on a user-configurable policy associated with identified data item category and based on the determined availability parameters associated with each of the plurality of data repository units.

19. The computer program product of claim 18, further comprising program instructions to monitor usage patterns of the plurality of data repository units.

20. The computer program product of claim 18, further comprising program instructions to forecast utilization of the plurality of data repository units for a predetermined forecast period based on historical trends of the usage patterns related to the plurality of data repository units and wherein the program instructions to distribute the plurality of data segments comprise program instructions to distribute the plurality of data segments among the plurality of data repository units based on the forecasted utilization of the plurality of data repository units.
